(19) United States
(12) Patent Application Publication
(10) Pub. No.: US 2014/0068535 A1
(43) Pub. Date: Mar. 6, 2014

(54) SYSTEM AND METHOD FOR CONFIGURING A TRANSISTOR DEVICE USING RX TUCK

(71) Applicants: Ismayil Arafath Babu, Bangalore (IN); Babruwahan Gade, Bangalore (IN); Preetham Kumar, Bangalore (IN)

(72) Inventors: Ismayil Arafath Babu, Bangalore (IN); Babruwahan Gade, Bangalore (IN); Preetham Kumar, Bangalore (IN)

(73) Assignee: ADVANCED MICRO DEVICES, INC., Sunnyvale, CA (US)

(21) Appl. No.: 13/622,566

(22) Filed: Sep. 19, 2012

(30) Foreign Application Priority Data
Aug. 31, 2012 (IN) 3619/CHE/2012

(51) Int. Cl. G06F 17/50

(52) U.S. Cl. 716/111

(57) ABSTRACT

The present disclosure relates to methods and systems for designing and fabricating an integrated circuit. In particular, a method includes electronically searching a virtual layout of an integrated circuit to locate a dummy polysilicon structure positioned between adjacent terminals of first and second MOSFET devices that are connected to different nodes of the integrated circuit. The method includes changing a configuration of the dummy polysilicon structure of the virtual layout to extend an active silicon region adjacent to the dummy polysilicon structure and to form an electrical connection between the dummy polysilicon structure and one of a supply voltage node and a ground node of the integrated circuit.

### CROSS-REFERENCE TO RELATED APPLICATION

The present application claims priority from and the benefit of Indian Patent Application No. 3619/CHE/2012, entitled “SYSTEM AND METHOD FOR CONFIGURING A TRANSISTOR DEVICE USING RX TUCK,” filed Aug. 31, 2012, the disclosure of which is incorporated herein by reference.

### FIELD OF THE DISCLOSURE

The present disclosure is generally related to the field of semiconductor design and manufacturing, and more particularly to methods and systems for configuring a metal oxide semiconductor (MOS) device using Rx tuck.

### BACKGROUND

Semiconductor device fabrication is a process for creating integrated circuits on a wafer of semiconducting substrate material, such as silicon, for example. Metal oxide semiconductor (MOS) devices are an exemplary type of semiconductor device. Exemplary MOS devices include MOS field effect transistors (MOSFETS) and MOS capacitors (MOSCAPs). A complementary MOS device (CMOS) includes both NMOS (negative polarity) and PMOS (positive polarity) circuits on a single chip device.

A group of interconnected MOSFET devices that provides a logic or storage function is referred to as a standard cell or logic cell. The MOSFET devices of each logic cell are formed adjacent to each other on the substrate, and an integrated circuit may include any number of logic cells. MOSFET devices typically include a semiconductor substrate (e.g., silicon substrate), a dielectric (e.g., oxide layer) formed on the surface of the substrate, and several terminals fabricated onto the substrate including a gate, a source, and a drain. Polysilicon is often used to form the gate terminal, and contacts (e.g., copper) covered in a metal layer are used for the source terminal and drain terminal. The substrate includes a substrate body that is doped to be either a “p-type” or an “n-type.” Further, diffusion regions are formed in the substrate at the source and drain by diffusing dopants into the substrate. The doped substrate body and the source and drain diffusion regions of the substrate are collectively referred to herein as the active silicon region or “active Rx.” The oxide layer, such as silicon dioxide (SiO₂) or other dielectric material, provides an insulation layer between the gate and the substrate body. The oxide layer may be used to pattern the source and drain diffusion regions. In an n-channel MOSFET (or “NMOS”) device, the diffusion regions at the source and drain are n-type diffusion regions with a p-type substrate body separating the two n-type diffusion regions. In a p-type MOS (or “PMOS”) device, the diffusion regions at the source and drain are p-type diffusion regions with an n-type substrate body separating the two p-type diffusion regions.

FIGS. 1 and 2 illustrate a top layout view of an exemplary known MOSFET 10 of a logic cell. MOSFET 10 may be a p-channel MOSFET or PMOS or an n-channel MOSFET or NMOS. FIG. 2 illustrates a cross-sectional view of MOSFET 10 taken along line 2-2 of FIG. 1. MOSFET 10 includes an active Rx 12 and a pair of contacts 20, 22 (e.g., copper) at respective drain and source terminals 40, 42 of MOSFET 10. Active Rx 12 is illustrated in the top-view of FIG. 1 with a rectangular perimeter. A polysilicon structure 16, or “poly” 16, functions as the gate terminal 16 of MOSFET 10. Poly 16 is referred to herein as the gate poly or gate terminal 16. Illustratively in FIGS. 1 and 2, drain terminal 40 is to the left of gate poly 16, and source terminal 42 is to the right of gate poly 16. For a PMOS 10, source terminal 42 is configured to connect to a supply voltage “VDD” node of the integrated circuit during operation of the PMOS 10, while drain terminal 40 is configured to connect to an output node of the logic cell. For an NMOS 10, source terminal 42 is configured to connect to a ground “VSS” node of the integrated circuit, while drain terminal 40 is configured to connect to an output node of the logic cell. Polysilicon structures 14, 18 provided on either side of gate poly 16 are referred to herein as “floating” or “dummy” polys 14, 18. Dummy polys 14, 18 do not function as transistor gates in the illustrated embodiment of FIGS. 1 and 2. Rather, dummy polys 14, 18 are provided for uniformity purposes during transistor fabrication. An oxide layer (not shown) serves as an insulation layer between gate poly 16 and active Rx 12.

Active Rx 12 includes a doped substrate body 24, a drain diffusion region 26, and a source diffusion region 28. Contacts 20, 22 are illustratively positioned in respective drain and source diffusion regions 26, 28 of active Rx 12. Drain diffusion region 26 and contact 20 cooperate to form drain terminal 40, and source diffusion region 28 and contact 22 cooperate to form source terminal 42. Contacts 20, 22 are connected to a metal layer (not shown) for connecting to nodes of the circuit or logic cell. The drain and source diffusion regions 26, 28 of the active Rx 12 for a PMOS device 10 are p-type and the substrate body 24 is n-type. For an NMOS device 10, the drain and source regions 26, 28 are doped as n-type and the substrate body 24 is doped as p-type.

The voltage applied to gate poly 16 controls current flow between the drain and source terminals 40, 42 of MOSFET 10. In particular, for a PMOS device 10, a p-type conducting channel 32 is formed between drain diffusion region 26 and source diffusion region 28 in the active Rx 12 when a negative voltage having a magnitude that exceeds a threshold is applied to gate poly 16, thereby “turning on” the PMOS 10. For an NMOS device 10, a positive voltage exceeding a threshold magnitude is applied to the gate poly 16 to form an n-type conducting channel 32 in the active Rx 12 and to thereby “turn on” the NMOS device 10.

In the exemplary MOSFET 10 of FIG. 2, contact 20 of drain 40 is illustratively punched through diffusion region 26 and entered into substrate body 24 at area 30 of active Rx 12. Because of the punch-through of contact 20 into substrate body 24, the conducting channel 32 between source 40 and drain 42 is compromised, and thus the electrical current (“I_{DS}”) between drain 40 and source 42 via channel 32 becomes highly variable and difficult to control.

Punch-through of the drain contact 20 is due at least in part to the active Rx 12 not being extended to dummy poly 14 (i.e., formed up to line A in FIG. 2). In particular, when the active Rx 12 is not extended to the dummy poly 14, a void 38 exists between the dummy poly 14 and the active Rx 12. As such, contact 20 may punch through to substrate body 24 during manufacturing due to reduced resistance from active Rx 12, and in particular from diffusion region 26. By comparison, the active Rx 12 is extended to or “tucked” beneath dummy poly 18 in FIG. 2, and source diffusion region 28 is illustratively formed up to line A. With the active Rx 12 extended to the dummy poly 18, referred to herein as “Rx tuck,” source contact 22 encounters more resistance (i.e., from the silicon material of active Rx 12) when inserted into diffusion region 28 during the manufacturing process such that contact 22 to reduce the likelihood of punching through to substrate body 24. MOSFET 10 is designed with void 38 near the drain 40, i.e., designed without Rx tuck to dummy poly 14, to avoid a transistor being formed with dummy poly 14 and another adjacent MOSFET 10 (not shown in FIG. 2).

Typically many MOSFET devices are manufactured on a chip space. For example, a single chip or integrated circuit may include thousands of MOSFET devices. While FIGS. 1 and 2 only illustrate a single MOSFET 10, an additional MOSFET may be on each side of MOSFET 10 such that dummy polys 14, 18 separate the three MOSFETs. In prior art MOSFET manufacturing, Rx tuck is performed on PMOS devices when the source terminals (e.g., source terminal 42 of FIGS. 1 and 2), which are configured to couple to a supply voltage node (VDD), of adjacent PMOS devices are adjacent to each other, as illustrated in FIG. 3. Similarly, Rx tuck is performed on NMOS devices in prior art devices when the drain terminals, which are configured to couple to a ground node (VSS), of adjacent NMOS devices are adjacent to each other, as illustrated in FIG. 4.

For example, FIG. 3 illustrates two adjacent PMOS transistors 50, 60 of an integrated circuit including a dummy poly 70 between the two transistors 50, 60 and dummy polys 72, 74 on opposite sides of transistors 50, 60. PMOS transistor 50 includes an active Rx 52, a drain 53 including a contact 54, and a source 55 including a contact 56. PMOS transistor 60 includes an active Rx 62, a drain 63 including a contact 64, and a source 65 including a contact 66. FIG. 3 illustrates that the adjacent source terminals 55, 65 of respective transistors 50, 60 are each configured to receive a power supply voltage VDD. In other words, source contacts 56, 66 are each coupled to a VDD node of the integrated circuit via respective metal layers or connections 58, 68. In FIG. 3, the active Rx 52, 62 of PMOS transistors 50, 60 are not tucked beneath the dummy poly 70. Rather, the active Rx 52, 62 are spaced apart from dummy poly 70, similar to the active Rx 12 of FIG. 2 being spaced apart from dummy poly 14. As such, a greater potential exists that source terminals 56, 66 will punch through into the substrate body of the respective active Rx 52, 62 during device manufacturing.

FIG. 4 illustrates at region 80 the active Rx 52, 62 tucked under the dummy poly 70, similar to the active Rx 12 of FIGS. 1 and 2 being tucked under dummy poly 18. An inoperable transistor is thus formed between the adjacent terminals 55, 65 with the active Rx 52, 62 formed adjacent the dummy poly 70. The transistor formed with the dummy poly 70 of FIG. 4 is inoperable because both adjacent terminals 56, 66 are source terminals that are coupled to a VDD node of the integrated circuit. As such, a conducting channel (e.g., see conducting channel 32 of FIG. 2) is not formed between source 55 and source 65 because both terminals 56, 66 are tied to VDD, thereby preventing the transistor from turning on when the gate voltage is applied to dummy poly 70.

FIGS. 5 and 6 illustrate a similar device configuration as FIGS. 3 and 4, except the two adjacent transistors 150, 160 of FIGS. 5 and 6 are NMOS transistors 150, 160 having source terminals that are coupled to a ground node VSS of the integrated circuit. Like components of NMOS transistors 150, 160 of FIGS. 5 and 6 and PMOS transistors 50, 60 of FIGS. 3 and 4 are provided with like reference numbers. An inoperable transistor is again formed between the adjacent terminals 155, 165 of FIG. 6 with the active Rx 152, 162 formed adjacent the dummy poly 170. The transistor formed with the dummy poly 170 of FIG. 6 is inoperable because both adjacent terminals 156, 166 are source terminals that are coupled to a VSS node. As such, a conducting channel (e.g., see conducting channel 32 of FIG. 2) is not formed between source 155 and source 165 of FIG. 6 because both terminals 156, 166 are tied to VSS, thereby preventing the transistor from turning on when the gate voltage is applied to dummy poly 170.

Integrated circuits are designed and simulated using available design tools, such as design software packages executing on one or more processors (e.g., electronic design automation (EDA) tools, computer-aided design (CAD) tools). The logic cells of an integrated circuit are typically designed in one or more displayed views provided with a virtual layout of the logic cells, such as a schematic view and/or a layout view. A schematic view or “netlist” illustrates the semiconductor devices and electrical connectivity of the devices. A layout view, such as the view illustrated in FIGS. 1 and 3-6, show a “top-down” physical representation of the logic cell or device. For example, the Calibre tool provided by Mentor Graphics includes integrated circuit design and simulation software. The Calibre tool is used to, for example, verify the virtual layout of an integrated circuit according to one or more design rules (e.g., a design rule check described herein). The Cadence SKILL engine is a tool for generating one or more data files that contain the virtual layout of the logic cells that is provided as input to an integrated circuit fabrication system for fabricating the integrated circuit. The schematic and/or layout views of the virtual layout of the integrated circuit may be provided on a display to allow a user to adjust and configure the virtual layout.

Several verification processes are provided with the design tools to confirm that the physical layout of the logic cell or integrated circuit meets design requirements, i.e., the components are logically correct and the device will function according to the logic. Design rule check (DRC) is a software tool (e.g., provided with Calibre or another suitable design tool) that is used to analyze the virtual layout of the integrated circuit in view of foundry and layout requirements set forth in a “rule deck” consisting of several design rules. The DRC tool flags violations of the design rules, which may include, for example, transistor spacing, metal layer thickness, power density, and other applicable design rules. Layout vs Schematic (LVS) is a software tool that when executed on one or more processors is used to compare the nodal connections of the physical layout with the schematic to verify the connectivity models are the same and to flag any violations.

The Rx tuck of the transistor configurations identified in FIGS. 4 and 6 is implemented at the design stage of the virtual layout of the logic cell. The circuit design tools are operative to identify each area of the integrated circuit that has the transistor configurations of FIGS. 3 and 5. In particular, the design tools are operative to identify areas where the transistors adjacent the dummy poly are either both PMOS or both NMOS and the adjacent terminals of the two adjacent transistors are both coupled to either VSS or VDD nodes, as described above with FIGS. 3-6. Upon identifying these two types of areas, the design tool is programmable to modify the virtual layout to perform Rx tuck at each of these identified areas in the virtual layout in an automated fashion such that the integrated circuit is fabricated with Rx tuck in these areas.

Current IC design tools do not provide an automated mechanism for configuring the virtual layout with Rx tuck in other transistor layout configurations. Exemplary configurations not having an automated design solution include when the transistor terminals adjacent to the intermediate dummy poly (e.g., dummy poly 70, 170) are node coupled to a same node type, i.e., the adjacent nodes to the dummy poly are not both connected to either VDD or VSS as described with FIGS. 3-6. As such, contact punch-through continues to be an issue when manufacturing integrated circuits with these configurations. Such configurations lacking an automated Rx tuck solution are illustrated in FIGS. 7-9. Referring to FIG. 7, the two adjacent PMOS transistors 50, 60 of FIG. 3 are illustrated with PMOS transistor 60 having a flipped orientation. In particular, the drain terminal 63 is adjacent dummy poly 70 while the source terminal 55 of PMOS transistor 50 is adjacent to dummy poly 70. Drain terminal 63 is coupled to an output node “node1” of the logic cell via metal layer 69. As such, if the active Rx 52, 62 is extended to dummy poly 70, an operable transistor is formed with dummy poly 70 functioning as a gate terminal between source terminal 55 and drain terminal 63. For example, a conducting channel may form between source 55 and drain 63 due to different electrical signals or potential at the source 55 and drain 63. As such, the functionality of the logic cell is changed with the new transistor, and the logic cell would fail a verification test.

Similarly, FIG. 8 illustrates the two adjacent NMOS transistors 150, 160 of FIG. 5 with NMOS transistor 160 having a flipped orientation such that drain terminal 163 is adjacent dummy poly 170. Drain terminal 163 is coupled to an arbitrary output node “node1” of the logic cell via metal layer 169. As such, if the active Rx 152, 162 is extended to dummy poly 170, an operable transistor is formed with dummy poly 170 functioning as a gate terminal between source terminal 155 and drain terminal 163. As such, the functionality of the logic cell is changed, the logic cell would fail a verification test. Similarly, FIG. 9 illustrates the two PMOS transistors 50, 60 of FIG. 3 with both transistors 50, 60 having a flipped orientation such that drain terminals 53, 63 are both adjacent dummy poly 70. Again, the functionality of the logic cell changes upon extending the active Rx 52, 62 to the dummy poly 70 due to different electrical signals or potential at the corresponding terminals, illustratively connected to node1 and node2 of the logic cell. The transistors 50, 60 of FIG. 9 may alternatively be NMOS transistors 150, 160 having drain terminals 153, 163 both adjacent to dummy poly 170 thereby creating a transistor with dummy poly 170 to change the logic cell functionality.

Current circuit design tools are not configured to identify transistor configurations illustrated in FIGS. 7-9 and are not configured to modify each area for extending the active Rx due to the configuration changes to the logic cell described above. A user may manually (e.g., with an input device such as a mouse pointer) modify each Rx tuck area in the virtual layout having the transistor configurations of FIGS. 7-9 by extending the active Rx and connecting the dummy poly 70, 170 to VDD or VSS. However, with each logic cell or integrated circuit often including thousands of transistors, the time, cost, and effort required for a user to adjust each Rx tuck area of the virtual layout is prohibitive.

Therefore a need exists for methods and systems that provide an automated mechanism for modifying the virtual layout of the integrated circuit with Rx tuck for all transistor configurations and orientations. As such, MOSFET devices may be fabricated such that source and drain contact depths are better controlled to reduce the likelihood of the contact punching through to the substrate body.

### SUMMARY OF EMBODIMENTS OF THE DISCLOSURE

In an exemplary embodiment of the present disclosure, a method of configuring an integrated circuit having a plurality of metal oxide semiconductor field effect transistor (MOSFET) devices is provided. The method includes electronically searching a virtual layout of an integrated circuit to locate a dummy polysilicon structure positioned between an adjacent terminal of a first MOSFET device and an adjacent terminal of a second MOSFET device. The adjacent terminal of the first MOSFET device is configured to connect to a first node of the integrated circuit, and the adjacent terminal of the second MOSFET device is configured to connect to a second node of the integrated circuit. The first and second nodes are configured to carry different electrical signals. The method further includes changing a configuration of the dummy polysilicon structure of the virtual layout to extend an active silicon region adjacent to the dummy polysilicon structure and to form an electrical connection between the dummy polysilicon structure and one of a supply voltage node and a ground node of the integrated circuit.

Among other advantages, some embodiments of the method and system of the present disclosure provide an automated mechanism for modifying the virtual layout of an integrated circuit with Rx tuck for all MOSFET configurations and orientations. As such, MOSFET devices may be fabricated such that source and drain contact depth are better controlled to reduce the likelihood of the contact punching through to the substrate body. Other advantages will be recognized by those of ordinary skill in the art.

In another exemplary embodiment of the present disclosure, a non-transitory computer-readable medium is provided. The non-transitory computer-readable medium includes executable instructions such that when executed by at least one processor cause the at least one processor to electronically search a virtual layout of an integrated circuit to locate a dummy polysilicon structure positioned between an adjacent terminal of a first MOSFET device and an adjacent terminal of a second MOSFET device. The adjacent terminal of the first MOSFET device is configured to connect to a first node of the integrated circuit, and the adjacent terminal of the second MOSFET device is configured to connect to a second node of the integrated circuit. The first and second nodes are configured to carry different electrical signals. The executable instructions when executed further cause the at least one processor to change a configuration of the dummy polysilicon structure of the virtual layout to extend an active silicon region adjacent to the dummy polysilicon structure and to form an electrical connection between the dummy polysilicon structure and one of a supply voltage node and a ground node of the integrated circuit.

In yet another exemplary embodiment of the present disclosure, a method of fabricating an integrated circuit having a plurality of metal oxide semiconductor field effect transistor (MOSFET) devices is provided. The method includes forming an electrical connection between a dummy polysilicon structure of the integrated circuit and one of a supply voltage node and a ground node of the integrated circuit based on an electronic search by at least one processor of a virtual layout of the integrated circuit. The electronic search locates a plurality of dummy polysilicon structures of the integrated circuit. The electronic search is configured to locate the dummy polysilicon structure based on a lack of connection of the dummy polysilicon structure to at least one of a contact layer and a metal layer of the integrated circuit. The dummy polysilicon structure is positioned between an adjacent terminal of a first MOSFET device and an adjacent terminal of a second MOSFET device. The adjacent terminal of the first MOSFET device is connected to a first node of the integrated circuit, and the adjacent terminal of the second MOSFET device is connected to a second node of the integrated circuit. The first and second nodes are configured to carry different electrical signals. The method further includes extending an active silicon region to an area adjacent to the dummy polysilicon structure such that the active silicon region extends from the first MOSFET device to the second MOSFET device and substantially abuts the dummy polysilicon structure.

In still another exemplary embodiment of the present disclosure, an integrated circuit fabrication system is provided that includes at least one processor and memory containing executable instructions. Execution of the executable instructions by the at least one processor cause the integrated circuit fabrication system to form an electrical connection between a dummy polysilicon structure of an integrated circuit and one of a supply voltage node and a ground node of the integrated circuit based on an electronic search of a virtual layout of the integrated circuit. The electronic search locates a plurality of dummy polysilicon structures of the integrated circuit. The electronic search is configured to locate the dummy polysilicon structure based on a lack of connection of the dummy polysilicon structure to at least one of a contact layer and a metal layer of the integrated circuit. The dummy polysilicon structure is positioned between an adjacent terminal of a first MOSFET device and an adjacent terminal of a second MOSFET device. The adjacent terminal of the first MOSFET device is connected to a first node of the integrated circuit, and the adjacent terminal of the second MOSFET device is connected to a second node of the integrated circuit. The first and second nodes are configured to carry different electrical signals. Execution of the executable instructions by the at least one processor further cause the integrated circuit fabrication system to extend an active silicon region to an area adjacent to the dummy polysilicon structure such that the active silicon region extends from the first MOSFET device to the second MOSFET device and substantially abuts the dummy polysilicon structure.

### BRIEF DESCRIPTION OF THE DRAWINGS

The invention will be more readily understood in view of the following description when accompanied by the below figures and wherein like reference numerals represent like elements:

FIG. 1 illustrates a layout view of an exemplary known MOSFET device positioned between a pair of dummy polys;

FIG. 2 illustrates a cross-sectional view of the MOSFET device of FIG. 1 taken along line 2-2 of FIG. 1 showing contact punch-through to a substrate body of the MOSFET device;

FIG. 3 illustrates a layout view of two adjacent PMOS devices with terminals adjacent to an intermediate dummy poly that are both coupled to supply voltage VDD;

FIG. 4 illustrates a layout view of the two adjacent PMOS devices of FIG. 3 with active silicon regions extended to the intermediate dummy poly between the two PMOS devices;

FIG. 5 illustrates a layout view of two adjacent NMOS devices with terminals adjacent to an intermediate dummy poly that are both coupled to ground VSS;

FIG. 6 illustrates a layout view of the two adjacent NMOS devices of FIG. 5 with active silicon regions extended to the intermediate dummy poly between the two NMOS devices;

FIG. 7 illustrates a layout view of two adjacent PMOS devices with terminals adjacent to an intermediate dummy poly that are coupled to different nodes;

FIG. 8 illustrates a layout view of two adjacent NMOS devices with terminals adjacent to an intermediate dummy poly that are coupled to different nodes;

FIG. 9 illustrates a layout view of two adjacent PMOS devices with terminals adjacent to an intermediate dummy poly that are coupled to different nodes;

FIG. 10 is a block diagram of an exemplary integrated circuit design system including Rx tuck logic and an exemplary integrated circuit fabrication system including circuit fabrication logic;

FIG. 11 illustrates a layout view of the two adjacent PMOS devices of FIG. 7 with active silicon regions extended to the dummy poly between the two PMOS devices and with the dummy poly coupled to supply voltage VDD;

FIG. 12 illustrates a layout view of the two adjacent NMOS devices of FIG. 8 with active silicon regions extended to the dummy poly between the two NMOS devices and with the dummy poly coupled to supply voltage VSS;

FIG. 13 illustrates a layout view of two adjacent PMOS devices of FIG. 9 with active silicon regions extended to the dummy poly between the two PMOS devices and with the dummy poly coupled to supply voltage VDD;

FIG. 14 is a flow chart of an exemplary method of operation of the Rx tuck logic of the integrated circuit design system of FIG. 10;

FIG. 15 is a flow chart of another exemplary method of operation of the Rx tuck logic of the integrated circuit design system of FIG. 10;

FIG. 16 is a flow chart of an exemplary method of operation of the circuit fabrication logic of the integrated circuit fabrication system of FIG. 10;

FIG. 17 illustrates a layout view of two adjacent PMOS devices having different transistor widths; and

FIG. 18 illustrates a layout view of the two adjacent PMOS devices of FIG. 17 including a modified Rx tuck area based on the different transistor widths.

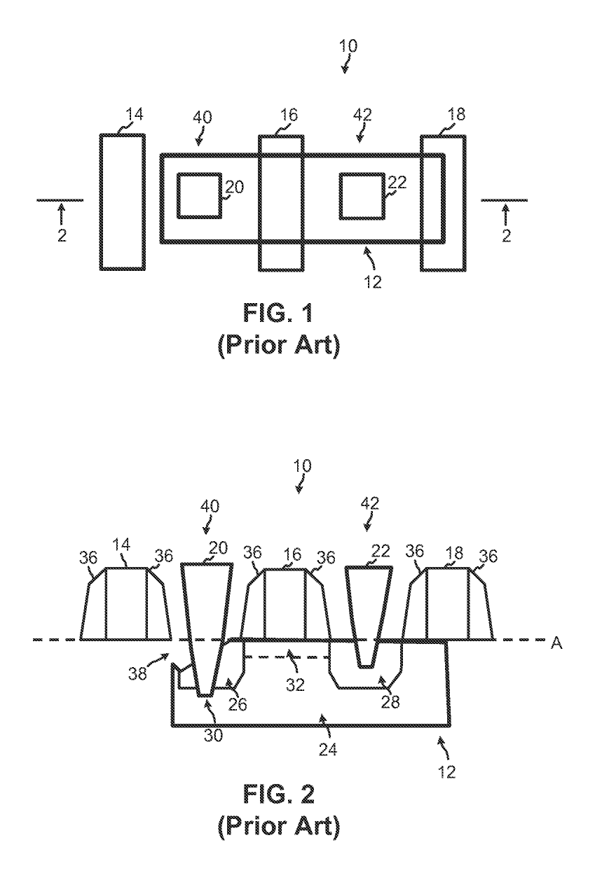

### DETAILED DESCRIPTION

The term “logic” or “control logic” as used herein includes software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the embodiments, various logic may be implemented in any appropriate fashion and would remain in accordance with the embodiments herein disclosed.

The terminology “circuit” and “circuitry” refers generally to hardwired logic that may be implemented using various discrete components such as, but not limited to, diodes, bipolar junction transistors (BJTs), field effect transistors (FETs), etc., which may be implemented on an integrated circuit using any of various technologies as appropriate, such as, but not limited to CMOS, NMOS, PMOS etc. A “logic cell” may contain various circuitry or circuits.

The term “node” as used herein indicates a connection point within a circuit or circuitry and may be a connection point between discrete components, an input connection point, an output connection point, etc. The node may be more than a connection and may include a discrete component that receives an input signal and changes states in response to the input signal. Therefore, the “node” may include one or more discrete components.

A computer readable medium/memory as referenced herein may be any suitable non-volatile memory such as, but not limited to, programmable chips such as EEPROMS, flash ROM (thumb drives), compact discs (CDs) digital video disks (DVDs), etc., (that may be used to load Hardware Description Language (HDL) and/or register-transfer level (RTL), and/or executable instructions or program code), or any other suitable medium so that the HDL, or other suitable data, may be used by various integrated circuit fabrication systems. Therefore, the embodiments herein disclosed include a computer readable medium/memory comprising executable instructions for execution by one or more processors. In one embodiment, the executable instructions are executed by an integrated circuit production system that cause the system to produce an integrated circuit comprising at least one integrated circuit logic cell in accordance with the embodiments herein described. The executable instructions may be HDL and/or RTL or any other suitable code and may include code to produce all of the features of the embodiments described herein.

“Node1” and “node2” as referenced herein includes any suitable nodes of the logic cell, other than the VSS and VDD nodes, and are not necessarily the same nodes in each referenced figure.

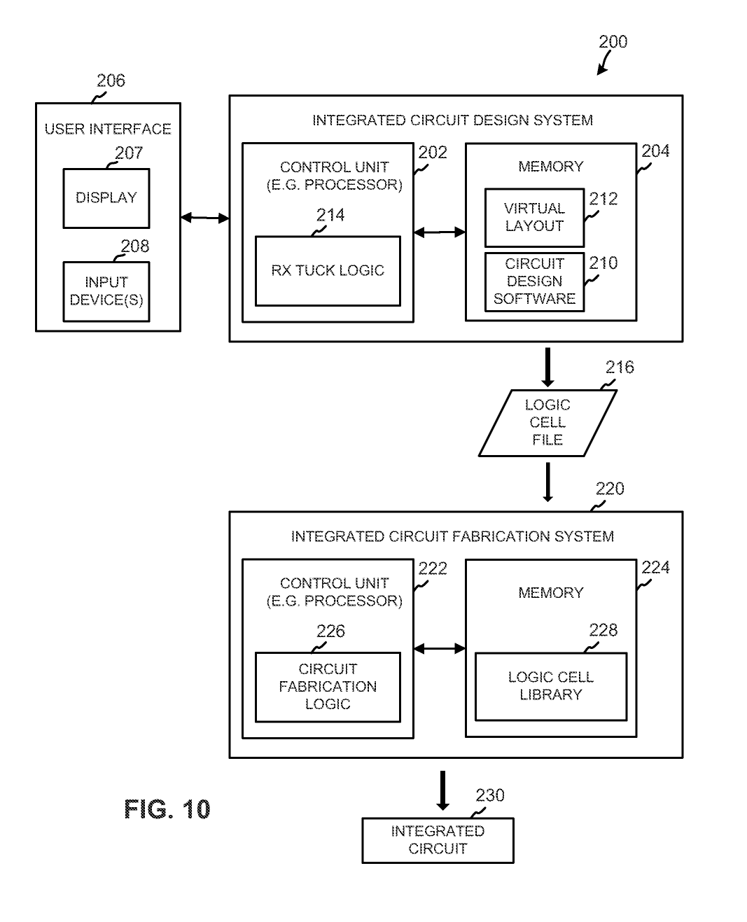

FIG. 10 illustrates an exemplary integrated circuit design system 200 according to various embodiments that is operative to configure a virtual layout of a logic cell or integrated circuit (IC) to reduce the likelihood of source/drain contact punch-through during manufacturing of the integrated circuit. Various other arrangements of internal and external components and corresponding connectivity of integrated circuit design system 200, that are alternatives to what is illustrated in the figures, may be utilized and such arrangements of internal and external components and corresponding connectivity would remain in accordance with the embodiments herein disclosed.

Referring to FIG. 10, integrated circuit design system 200 includes a control unit 202 (e.g., one or more processing devices), memory 204 that is accessible by control unit 202, and a user interface 206 including a display 207 for displaying data provided by control unit 202. Memory 204 includes one or more physical memories such as read only memory (ROM), random access memory (RAM), or any other suitable memory type. A virtual layout 212 of one or more integrated circuit logic cells is stored in memory 204 and comprises virtual layout data that is searchable and modifiable by control unit 202. Exemplary data displayed on display 207 includes data providing one or more views of virtual layout 212 that is configurable by a user with one or more input devices 208 (e.g., keyboard, mouse pointer, touchscreen, etc.) of user interface 206. Control unit 202 is operative to execute one or more integrated circuit design and simulation tools, illustratively circuit design software 210 stored in memory 204, for generating the virtual layout 212 of the integrated circuit. In particular, control unit 202 executes circuit design software 210 stored in memory 204 to create the virtual layout 212 of the integrated circuit based on user input provided via user interface 206. In the illustrated embodiment, circuit design software 210 includes the Calibre tool and the Cadence SKILL engine comprising code modules stored in memory 204, as described herein. Other suitable software modules may be provided for creating and designing the integrated circuit.

Control unit 202 includes Rx tuck logic 214 that is operative to configure the virtual layout 212 of the integrated circuit according to the methods described herein. For example, the Rx tuck logic 214 identifies and configures the areas of the virtual layout 212 of the logic cell where the active Rx is to be extended or added. In one embodiment, the Rx tuck logic 214 operates in conjunction with the execution of the circuit design software 210 stored in memory 204. For example, the Rx tuck logic 214 operates within the software framework of the Calibre tool and/or Cadence SKILL engine. As such, upon Rx tuck logic 214 identifying and configuring the Rx tuck areas, control unit 202 executes the appropriate software module of the Calibre tool to verify the virtual layout 212 of the logic cell according to one or more design rules (e.g., the design rule check described herein). Upon calculating the areas of the logic cell where active Rx is to be extended, the Rx tuck logic 214 outputs the calculated areas to the Cadence SKILL engine. The executed Cadence SKILL engine tool is operative to generate a file 216 identifying the virtual layout 212 of the integrated circuit based on the input provided with the Rx tuck logic 214. Other software, firmware, and logic may be provided for designing and verifying the virtual layout 212 of the integrated circuit.

The file 216 generated by the control unit 202 executing software 210 that identifies the logic cell design is provided as input to an integrated circuit fabrication system 220. Fabrication system 220 includes a control unit 222 (e.g., one or more processing devices) and memory 224 that is accessible by control unit 222. Memory 224 (e.g., ROM, RAM, etc.) includes a logic cell library 228 that includes a plurality of logic cell layouts used in the production of integrated circuits. File 216 is stored in the logic cell library 228. Control unit 222 includes circuit fabrication logic 226 that is operative to cause the integrated circuit fabrication system 220 to produce an integrated circuit 230 having a layout based on the virtual layout 212 configured with integrated circuit design system 200 and identified in the generated logic cell file 216.

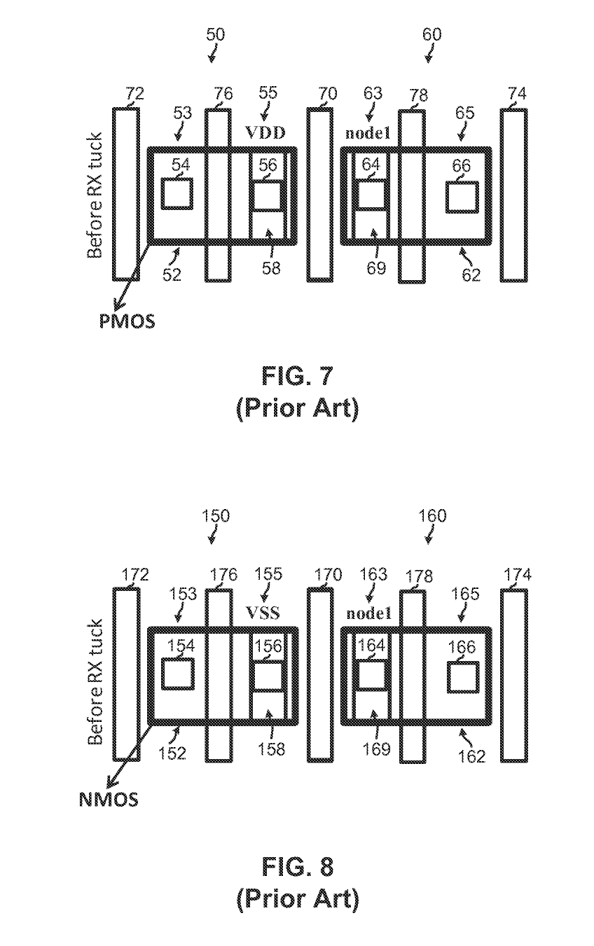

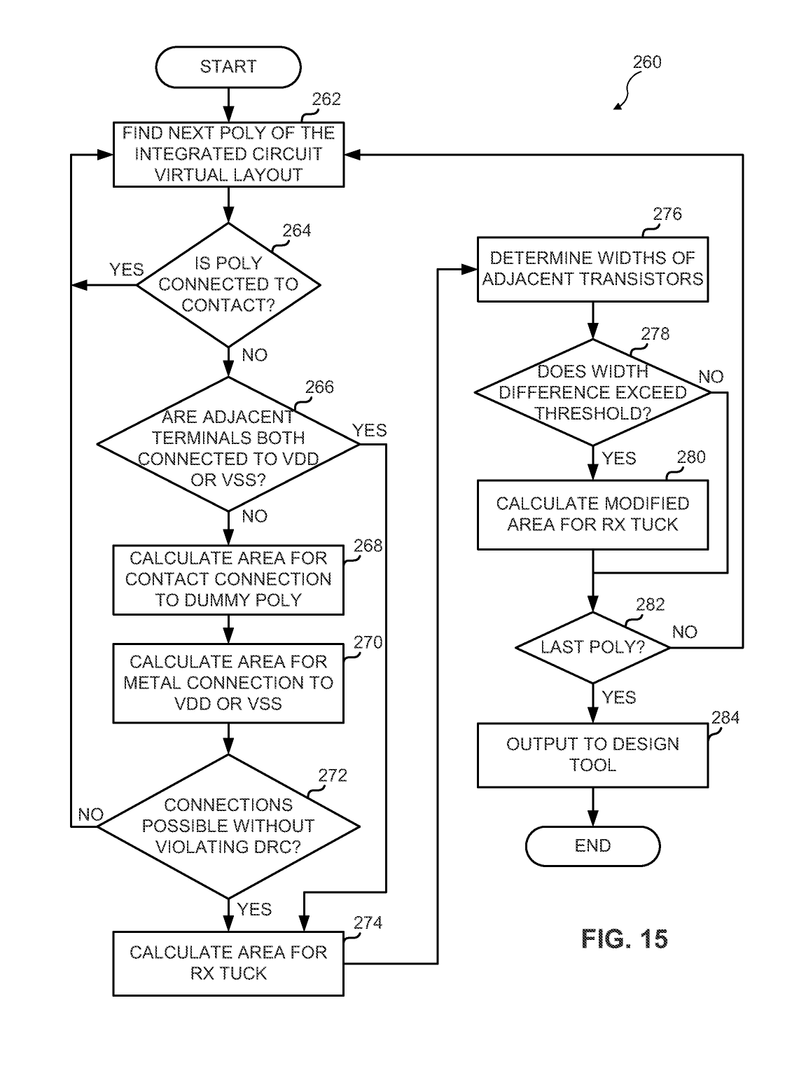

Rx tuck logic 214 of FIG. 10 is operative to configure a virtual layout 212 of a logic cell with Rx tuck in the transistor configurations illustrated in FIGS. 11-14, as described herein with respect to the methods of FIGS. 15-17. Referring to FIG. 11, the two adjacent PMOS transistors 50, 60 of FIG. 7 are illustrated in a top layout view of the virtual layout 212 with drain terminal 63 of PMOS 60 and source terminal 55 of PMOS 50 adjacent dummy poly 70. Drain terminal 63 is coupled to output node “node1” of the logic cell carrying an electric signal or potential different from VDD. Rx tuck logic 214 extends the active Rx 52, 62 adjacent to dummy poly 70, as described herein. In addition, Rx tuck logic 214 adds a contact 90 (e.g., copper) to dummy poly 70 and connects the contact 90 to metal connection 58 with an added metal connection 92. As such, with both source terminal 55 and dummy poly 70 tied to the supply voltage VDD node and with the active Rx extended, an inoperable transistor is formed with dummy poly 70, source 55, and drain 63, i.e., the formed transistor will not turn on due to dummy poly 70 being tied to the supply voltage VDD. As such, the inoperable transistor formed with dummy poly 70, which is no longer “floating” due to the added active Rx, is configured such that the functionality or logic of the logic cell is not changed with Rx tuck.

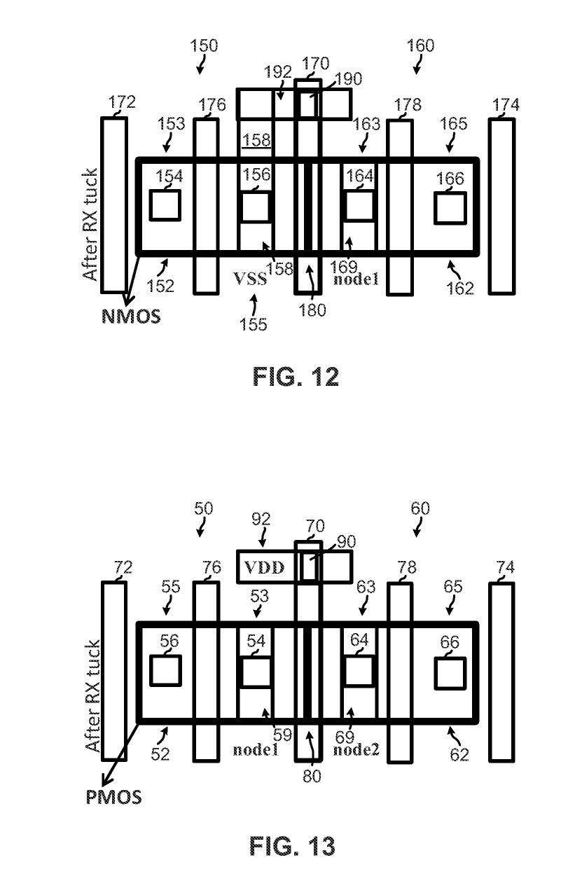

Similarly, FIG. 12 illustrates the two adjacent NMOS transistors 150, 160 of FIG. 8 in a top layout view of a virtual layout 212 with drain terminal 163 of NMOS 160 and source terminal 155 of NMOS 150 adjacent dummy poly 170. Drain terminal 163 is coupled to an output node “node1” of the logic cell carrying an electric signal or potential different from VSS. Rx tuck logic 214 extends the active Rx 152, 162 adjacent to dummy poly 170, as described herein. In addition, Rx tuck logic 214 adds a contact 190 (e.g., copper) to dummy poly 170 and connects the contact 190 to metal connection 158 with an added metal connection 192. As such, with both source terminal 155 and dummy poly 170 tied to the ground VSS node and with the active Rx extended, an inoperable transistor is formed with dummy poly 170, source 155, and drain 163, i.e., the formed transistor will not turn on due to dummy poly 170 being tied to the ground VSS node. As such, the inoperable transistor formed with dummy poly 170, which is no longer “floating” due to the added active Rx, is configured such that the functionality or logic of the logic cell is not changed with Rx tuck.

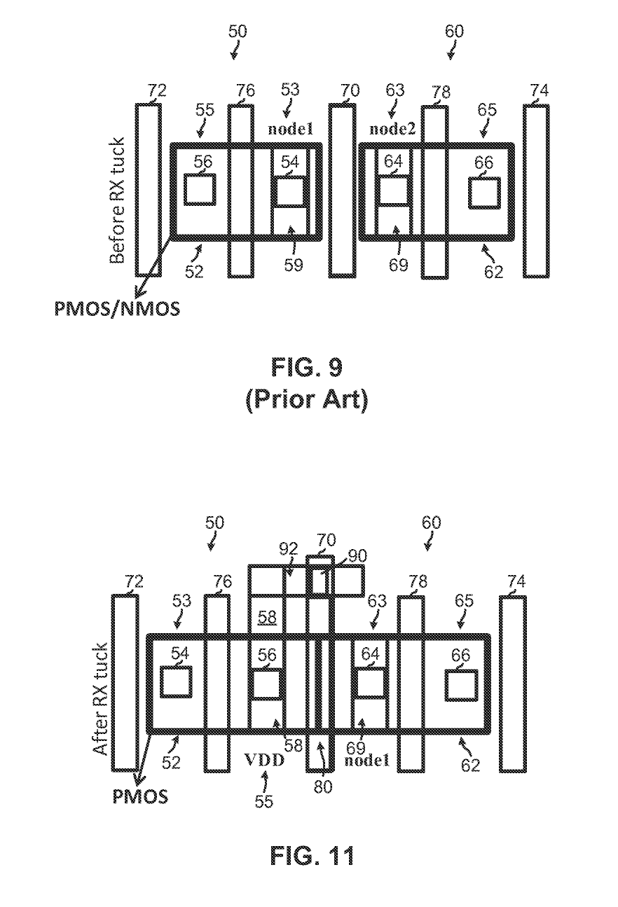

Similarly, FIG. 13 illustrates the two adjacent PMOS transistors 50, 60 of FIG. 9 are illustrated in a top layout view of a virtual layout 212 with drain terminal 53 of PMOS 50 and drain terminal 63 of PMOS 60 both adjacent dummy poly 70. Drain terminals 53, 63 are coupled to any suitable output nodes, illustratively “node1” and “node2,” of the logic cell carrying electric signals or potential different from VDD and VSS. Rx tuck logic 214 extends the active Rx 52, 62 adjacent to dummy poly 70, as described herein. In addition, Rx tuck logic 214 adds a contact 90 (e.g., copper) to dummy poly 70 and connects the contact 90 to an added metal connection 92 which is routed to a supply voltage node VDD. As such, with dummy poly 70 tied to the supply voltage VDD node and with the active Rx extended, an inoperable transistor is formed with dummy poly 70 and terminals 53, 63, i.e., the formed transistor will not turn on due to dummy poly 70 being tied to the supply voltage VDD. As such, the inoperable transistor formed with dummy poly 70, which is no longer “floating” due to the added active Rx, is configured such that the functionality or logic of the logic cell is not changed with the Rx tuck. In an embodiment with adjacent NMOS transistors 150, 160 having adjacent drain terminals 153, 163, Rx tuck logic 214 similarly adds a contact and metal connection (e.g., see contact 190 and metal connection 192 of FIG. 12) to couple the dummy poly 170 to ground VSS to render the formed transistor inoperable.

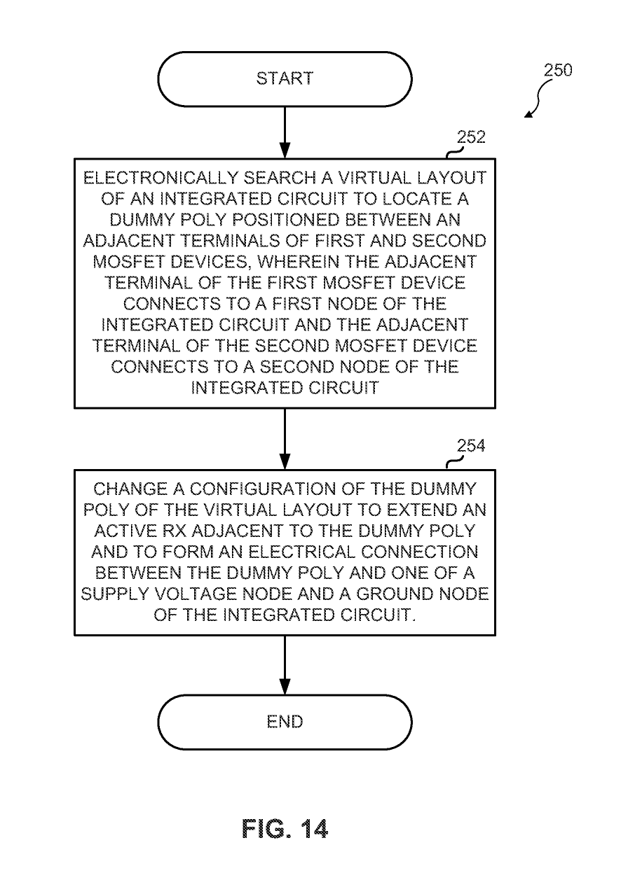

FIGS. 14 and 15 illustrate flow diagrams 250, 260 of exemplary operations performed by Rx tuck logic 214 of FIG. 10 for configuring a logic cell of an integrated circuit. As described herein, Rx tuck logic 214 changes the configuration of the logic cell by modifying virtual layout data of virtual layout 212 that is associated with the dummy poly (e.g., dummy poly 70, 170), the active Rx (e.g., active Rx 52, 152, 62, 162), the metal layer (e.g., metal connections 58, 158, 92, 192, the contact layer (e.g., contacts 90, 190), and other suitable logic cell components. Reference is made to FIGS. 10-13 throughout the description of FIGS. 14 and 15.

Referring to flow diagram 250 of FIG. 14, Rx tuck logic 214 electronically searches virtual layout 212 of an integrated circuit at block 252 to locate a dummy polysilicon structure (e.g., dummy poly 70, 170) positioned between an adjacent terminal of a first MOSFET device and an adjacent terminal of a second MOSFET device. The adjacent terminal of the first MOSFET device is configured to connect to a first node of the integrated circuit, and the adjacent terminal of the second MOSFET device is configured to connect to a second node of the integrated circuit. The first and second nodes are configured to carry different electrical signals. In the illustrated embodiment, Rx tuck logic 214 electronically searches by locating each of a plurality of polysilicon structures of the integrated circuit in the virtual layout 212 including gate polysilicon structures and dummy polysilicon structures. Rx tuck logic 214 identifies each dummy polysilicon structure based on a lack of connection of the dummy polysilicon structure to at least one of a contact layer and a metal layer of the integrated circuit.

As one example of block 252, Rx tuck logic 214 locates dummy poly 70 of FIG. 11 positioned between adjacent source terminal 55 of PMOS 50 and adjacent drain terminal 63 of PMOS 60. Source terminal 55 is coupled to VDD node, and drain terminal 63 is coupled to an output node “node1” that carries a different electrical signal or potential as the VDD node. Rx tuck logic 214 locates each gate poly (e.g., gate poly 76, 78, etc.) and dummy poly (e.g., dummy poly 70, 72, 74) of the logic cell by identifying virtual layout data of virtual layout 212 representing the gate polys and dummy polys. The dummy polys are identified as “floating” and not being connected to a metal layer or contact, and the gate polys are identified based on connections to a contact and metal layer of the logic cell.

At block 254, Rx tuck logic 214 changes a configuration of the located dummy polysilicon structure of the virtual layout 212 to extend an active silicon region adjacent to the dummy polysilicon structure and to form an electrical connection between the dummy polysilicon structure and one of a supply voltage node and a ground node of the integrated circuit. For example, Rx tuck logic 214 modifies the virtual layout data of virtual layout 212 to extend active Rx 52, 62 to dummy poly 70 of FIG. 11 and to form metal connections 92, 58 to electrically connect dummy poly 70 to supply voltage VDD. In the illustrated embodiment, Rx tuck logic 214 calculates an area of the logic cell adjacent the dummy poly 70 where the active Rx 52, 62 is to be extended, calculates an area of the logic cell adjacent the dummy poly 70 for connection of contact 90 to the dummy poly 70, and calculates an area of the logic cell for metal connection 92, 58 between contact 90 and the supply voltage VDD node.

In one embodiment, Rx tuck logic 214 evaluates the changed configuration of dummy poly 70 in the virtual layout to determine whether a spacing between the electrical path forming the electrical connection (e.g., metal connections 92, 58) and a nearest other electrical path of the virtual layout 212 of the logic cell exceeds a minimum spacing threshold. The minimum spacing threshold may be any suitable distance provided in a design rule set, for example. If the spacing exceeds the threshold, Rx tuck logic 214 searches for an alternative area to make the electrical connection or determines that the electrical connection cannot be made without exceeding the threshold. If the electrical connection cannot be made, Rx tuck logic 214 in one embodiment does not implement Rx tuck at the dummy poly 70.

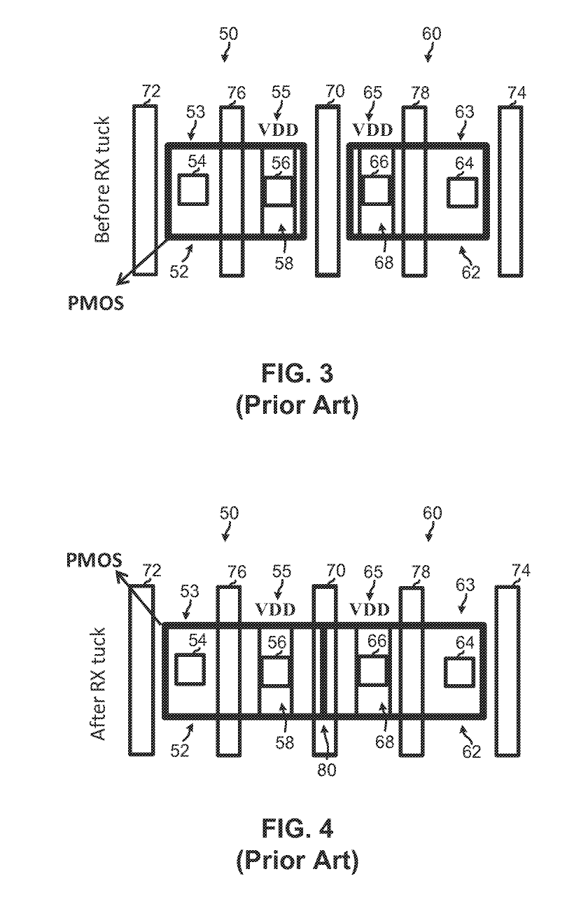

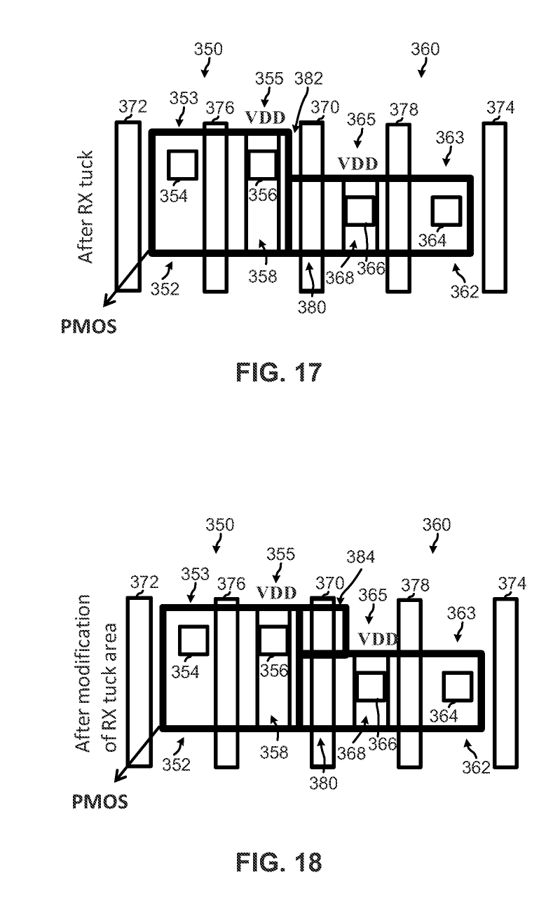

In one embodiment, Rx tuck logic 214 further determines the width of the adjacent first and second MOSFET devices identified at block 252. Upon the difference in the widths of the MOSFET devices exceeding a difference threshold, Rx tuck logic 214 calculates a modified area adjacent the dummy poly where the active Rx is to be added such that the modified Rx tuck area extends substantially along the entire width of each of the first and second MOSFET devices. For example, referring to FIG. 17, two adjacent PMOS transistors 350, 360 are illustrated. Like components of PMOS transistors 350, 360 of FIGS. 17 and 18 and PMOS transistors 50, 60 of FIGS. 3 and 4 are provided with like reference numbers. PMOS transistors 350, 360 are illustrated having different widths. In particular, the width of PMOS 350 (extending along dummy poly 370) is greater than the width of PMOS 360, as illustrated. Source terminals 355, 365 are each adjacent to the intermediate dummy poly 370 in the illustrative transistor configuration of FIGS. 17 and 18. The active Rx 352, 362 is extended to dummy poly 70 in FIG. 17 according to the method of FIG. 14 as shown at Rx tuck region 380. However, as shown a gap 382 exists between the active Rx 352 of PMOS 350 and the dummy poly 370 where the upper portion of active Rx 352 is not extended due to the difference in transistor widths. With a portion of source terminal 355 being adjacent the gap 382, a greater potential exists for punch-through of contact 356 into the transistor substrate during device manufacturing, as described herein. As such, Rx tuck logic 214 calculates a modified Rx tuck area by extending the active Rx, illustratively active Rx 352, to dummy poly 170 to create Rx tuck region 384 of the virtual layout 212. The modified Rx tuck area extends substantially along the widths of both PMOS devices 350, 360. Rx tuck logic 214 calculates and implements a modified Rx tuck area similar to the combined regions 380, 384 for the other transistor configurations described herein upon the width difference between adjacent MOSFETs receiving the Rx tuck exceeding a threshold. Any suitable width difference threshold may be provided for implementing the modified Rx tuck area. In one embodiment, the MOSFET width difference is calculated and compared to the threshold prior to initially calculating the Rx tuck area such that the Rx tuck area is initially calculated based on consideration of differing MOSFET widths.

Referring to FIG. 15, a flow diagram of an exemplary detailed method of operation of Rx tuck logic 214 is illustrated. At block 262, Rx tuck logic 214 locates a next polysilicon structure during the electronic search of the virtual layout 212. At block 264, Rx tuck logic 214 determines whether the located polysilicon structure is connected to a contact. If yes, Rx tuck logic 214 determines that the located polysilicon structure is a gate poly (e.g., gate poly 76, 78 of FIG. 11) which does not require Rx tuck and returns to block 262 to locate the next polysilicon structure. If the located polysilicon structure is not connected to a contact at block 264, Rx tuck logic 214 determines that the polysilicon structure is a dummy poly (e.g., dummy poly 70 of FIG. 11) and proceeds to block 266 to determine if the adjacent terminals of the adjacent MOSFETs are both connected to either voltage supply VDD or ground VSS nodes. If yes at block 266, Rx tuck logic 214 proceeds to block 274 to calculate the area for Rx tuck. If no at block 266, Rx tuck logic 214 determines that the configuration of the dummy poly requires modification, as described herein with respect to FIG. 14. As such, at block 268 Rx tuck logic 214 calculates the area for adding a contact (e.g., contact 90 of FIG. 11) to the dummy poly, and at block 270 Rx tuck logic 214 calculates the area for adding a metal connection (e.g., metal connection 92, 58) to connect the contact to VDD or VSS. At block 272, Rx tuck logic 214 determines if the contact and metal connections are possible without violating any design rules and limitations, as described herein with respect to the design rule check (“DRC”). An exemplary DRC rule includes a minimum spacing requirement between metal connections of the logic cell. If the contact and metal connections cannot be added without violating DRC, Rx tuck logic 214 determines that Rx tuck cannot be performed at the current dummy poly and returns to block 262 to locate the next polysilicon structure of the virtual layout 212. If the contact and metal connections can be added without violating DRC at block 272, Rx tuck logic 214 proceeds to block 274 to calculate the area of the virtual layout 212 for Rx tuck.

At block 276, Rx tuck logic 214 determines the widths of the adjacent MOSFET devices. If the width difference exceeds a threshold at block 278, Rx tuck logic 214 calculates a modified Rx tuck area, as described herein with respect to FIG. 15. If the width difference does not exceed the threshold at block 278, Rx tuck logic 214 determines the current Rx tuck area is suitable and proceeds to block 282 to determine if the current dummy poly is the last polysilicon structure of the virtual layout 212, i.e., if all polysilicon structures of the virtual layout 212 have been identified. If no at block 282, Rx tuck logic 214 returns to block 262 to find the next poly. If yes at block 282, Rx tuck logic 214 proceeds to block 284 to output the calculated Rx tuck area of the virtual layout 212 to a circuit design tool. For example, Rx tuck logic 214 outputs data identifying the calculated Rx tuck area to the control unit 102 executing the circuit design software 210 of FIG. 10 (e.g., Cadence SKILL engine or other suitable design software). Control unit 102 generates the logic cell file 216 based on the calculated Rx tuck area such that integrated circuit fabrication system 220 manufactures one or more logic cells of the integrated circuit 230 with the calculated Rx tuck areas.

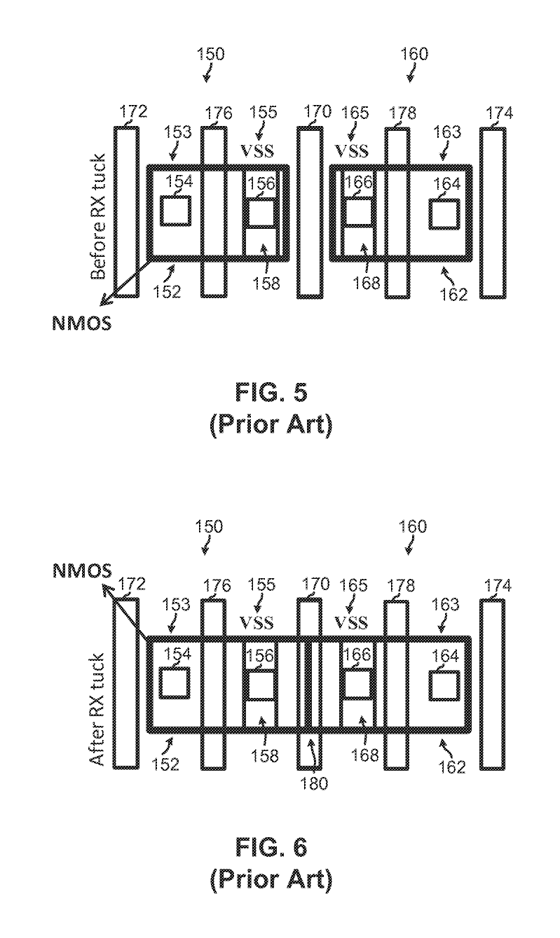

The methods of FIGS. 14 and 15, while described herein with respect to the transistor configuration of FIG. 11, may be similarly applied to other transistor configurations, such as the configurations illustrated in FIGS. 3-6, 12, and 13 and described herein.

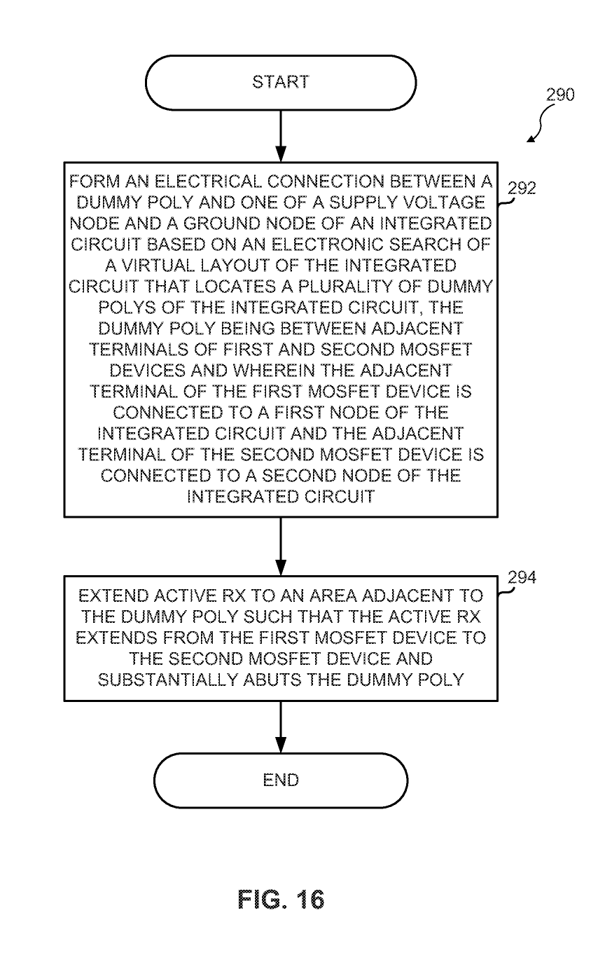

Referring to FIG. 16, a flow diagram 290 is illustrated of an exemplary operation performed by integrated circuit fabrication system 220 of FIG. 10 for fabricating an integrated circuit 230 based on the logic cell file 216 provided by integrated circuit design system 200. While flow diagram 290 is described with respect to FIG. 11, the flow diagram 290 may be similarly implemented with other transistor configurations, such as the configurations illustrated in FIGS. 3-6, 12, and 13 and described herein. At block 292, fabrication system 220 forms an electrical connection (e.g., 92, 58 of FIG. 11) between a dummy polysilicon structure (e.g., dummy poly 70) of the integrated circuit and one of a supply voltage VDD node and a ground VSS node of the integrated circuit based on an electronic search by at least one processor (e.g., control unit 202) of a virtual layout 212 of the integrated circuit. As described herein with respect to FIGS. 14 and 15, the electronic search by Rx tuck logic 214 locates a plurality of dummy polysilicon structures of the integrated circuit and is configured to locate the dummy poly 70 based on a lack of connection of the dummy poly 70 to at least one of a contact layer and a metal layer of the integrated circuit. The dummy poly 70 is positioned between an adjacent terminal 55 of a first MOSFET device (e.g., PMOS 50) and an adjacent terminal 63 of a second MOSFET device (e.g., PMOS 60), as described herein. The adjacent terminal 55 of the first MOSFET device is connected to a first node (VDD) of the integrated circuit and the adjacent terminal of the second MOSFET device is connected to a second node (node1) of the integrated circuit, as described herein. The first and second nodes are configured to carry different electrical signals, as described herein.

At block 294, fabrication system 220 extends an active silicon region (e.g., active Rx 52, 62) to an area 80 adjacent to the dummy poly 70 such that the active silicon region extends from the first MOSFET device to the second MOSFET device and substantially abuts the dummy polysilicon structure, as described herein. In the illustrated embodiment, fabrication system 220 forms the electrical connection at block 292 by adding a contact 90 to the dummy poly 70 and adding a metal connection 92, 58 between the contact 90 and the supply voltage VDD node or the ground VSS node, as described herein. The electrical connection is formed by fabrication system 220 based on a determination by Rx tuck logic 214 that a spacing between the electrical connection and a nearest electrical path of the integrated circuit exceeds a minimum spacing threshold, as described herein.

Among other advantages, embodiments of the method and system of the present disclosure provide an automated mechanism for modifying the virtual layout of an integrated circuit with Rx tuck for all MOSFET configurations and orientations. As such, MOSFET devices may be fabricated such that source and drain contact depth are better controlled to reduce the likelihood of the contact punching through to the substrate body. Other advantages will be recognized by those of ordinary skill in the art.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this disclosure pertains and which fall within the limits of the appended claims.

1. A method of configuring an integrated circuit having a plurality of metal oxide semiconductor field effect transistor (MOSFET) devices, the method comprising:
electronically searching, by an integrated circuit design system, a virtual layout of an integrated circuit to locate a dummy polysilicon structure positioned between an adjacent terminal of a first MOSFET device and an adjacent terminal of a second MOSFET device wherein the adjacent terminal of the first MOSFET device is connected to a first node of the integrated circuit and the adjacent terminal of the second MOSFET device is connected to a second node of the integrated circuit, the first node and the second node being configured to have different electric potentials; and
electronically changing, by the integrated circuit design system, a configuration of the dummy polysilicon structure of the virtual layout from an initial configuration wherein an active silicon region is spaced apart from the dummy polysilicon structure to a changed configuration wherein the active silicon region is extended to the dummy polysilicon structure and an electrical connection is formed between the dummy polysilicon structure and one of a supply voltage node and a ground node of the integrated circuit.

2. The method of claim 1, wherein changing the configuration of the dummy polysilicon structure of the virtual layout comprises
calculating an area adjacent the dummy polysilicon structure where the active silicon region is to be extended,
calculating an area adjacent the dummy polysilicon structure for connection of a contact to the dummy polysilicon structure, and
calculating an area for a metal connection between the contact and the at least one of the supply voltage node and the ground voltage node.

3. The method of claim 2, wherein the first MOSFET device and the second MOSFET device each have a width, a length, and a thickness, the dummy polysilicon structure extending along the widths of the first MOSFET device and the second MOSFET device and extending substantially perpendicular to the lengths of the first MOSFET device and the second MOSFET device, the method further comprising
determining the width of the first MOSFET device and the width of the second MOSFET device, and
calculating a modified area adjacent the dummy polysilicon structure where the active silicon region is to be added upon the difference in the widths of the first MOSFET device and the second MOSFET device exceeding a difference threshold, wherein the modified area extends substantially along the entire width of each of the first MOSFET device and the second MOSFET device.

4. The method of claim 1, further comprising evaluating the changed configuration of the dummy polysilicon structure in the virtual layout and determining whether a spacing between an electrical path forming the electrical connection and a nearest electrical path of the virtual layout of the integrated circuit exceeds a minimum spacing threshold.

5. The method of claim 1, wherein the electronically searching comprises locating each of a plurality of polysilicon structures of the integrated circuit in the virtual layout, the plurality of polysilicon structures comprising gate polysilicon structures and dummy polysilicon structures, and identifying each dummy polysilicon structure based on a lack of connection of the dummy polysilicon structure to at least one of a contact layer and a metal layer of the integrated circuit.

6. The method of claim 1, wherein the first node and the second node comprise at least two of a supply voltage node coupled to a supply voltage of the integrated circuit, a ground node coupled to a ground of the integrated circuit, and an output node, the output node being configured to have an electric potential different from the supply voltage and the ground.

7. The method of claim 1, wherein the adjacent terminal of the first MOSFET device is a source terminal and the adjacent terminal of the second MOSFET device is a drain terminal.

8. A non-transitory computer-readable medium comprising:
executable instructions such that when executed by at least one processor cause the at least one processor to:
electronically search a virtual layout of an integrated circuit to locate a dummy polysilicon structure positioned between an adjacent terminal of a first MOSFET device and an adjacent terminal of a second MOSFET device wherein the adjacent terminal of the first MOSFET device is connected to a first node of the integrated circuit and the adjacent terminal of the second MOSFET device is connected to a second node of the integrated circuit, the first node and the second node being configured to have different electric potentials; and
electronically change a configuration of the dummy polysilicon structure of the virtual layout from an initial configuration wherein an active silicon region is spaced apart from the dummy polysilicon structure to a changed configuration wherein the active silicon region is extended to the dummy polysilicon structure and an electrical connection is formed between the dummy polysilicon structure and one of a supply voltage node and a ground node of the integrated circuit.

9. The non-transitory computer-readable medium of claim 8, wherein the at least one processor changes the configuration by:
calculating an area adjacent the dummy polysilicon structure where the active silicon region is to be extended,
calculating an area adjacent the dummy polysilicon structure for connection of a contact to the dummy polysilicon structure, and
calculating an area for a metal connection between the contact and the at least one of the supply voltage node and the ground voltage node.

10. The non-transitory computer-readable medium of claim 9, wherein the first MOSFET device and the second MOSFET device each have a width, a length, and a thickness, and the dummy polysilicon structure extends along the widths of the first MOSFET device and the second MOSFET device and extends substantially perpendicular to the lengths of the first MOSFET device and the second MOSFET device, wherein the executable instructions further cause the at least one processor to:
determine the width of the first MOSFET device and the width of the second MOSFET device; and
calculate a modified area adjacent the dummy polysilicon structure where the active silicon region is to be extended upon the difference in the widths of the first MOSFET device and the second MOSFET device exceeding a difference threshold, wherein the modified area extends substantially along the entire width of each of the first MOSFET device and the second MOSFET device.

11. The non-transitory computer-readable medium of claim 8, wherein the executable instructions further cause the at least one processor to evaluate the changed configuration of the dummy polysilicon structure in the virtual layout and to determine whether a spacing between an electrical path forming the electrical connection and a nearest electrical path of the virtual layout of the integrated circuit exceeds a minimum spacing threshold.

12. The non-transitory computer-readable medium of claim 8, wherein the at least one processor electronically searches by locating each of a plurality of polysilicon structures of the integrated circuit in the virtual layout, the plurality of polysilicon structures comprising gate polysilicon structures and dummy polysilicon structures, and identifying each dummy polysilicon structure based on a lack of connection of the dummy polysilicon structure to at least one of a contact layer and a metal layer of the integrated circuit.

13. The non-transitory computer-readable medium of claim 8, wherein the first node and the second node comprise at least two of a supply voltage node coupled to a supply voltage of the integrated circuit, a ground node coupled to a ground of the integrated circuit, and an output node, the output node being configured to have an electric potential different from the supply voltage and the ground.

14. The non-transitory computer-readable medium of claim 8, wherein the adjacent terminal of the first MOSFET device is a source terminal and the adjacent terminal of the second MOSFET device is a drain terminal.

15. A method of fabricating an integrated circuit having a plurality of metal oxide semiconductor field effect transistor (MOSFET) devices, the method comprising:
forming an electrical connection between a dummy polysilicon structure of the integrated circuit and one of a supply voltage node and a ground node of the integrated circuit based on an electronic search by at least one processor of an integrated circuit design system of a virtual layout of the integrated circuit that locates a plurality of dummy polysilicon structures of the integrated circuit, the electronic search performed by the integrated circuit design system locating the dummy polysilicon structure based on a lack of connection of the dummy polysilicon structure to at least one of a contact layer and a metal layer of the integrated circuit, the dummy polysilicon structure being positioned between an adjacent terminal of a first MOSFET device and an adjacent terminal of a second MOSFET device wherein the adjacent terminal of the first MOSFET device is connected to a first node of the integrated circuit and the adjacent terminal of the second MOSFET device is connected to a second node of the integrated circuit, the first node and the second node being configured to have different electric potentials; and
extending an active silicon region to an area adjacent to the dummy polysilicon structure such that the active silicon region extends from the first MOSFET device to the second MOSFET device and substantially abuts the dummy polysilicon structure.

16. The method of claim 15, wherein forming the electrical connection comprises adding a contact to the dummy polysilicon structure and adding a metal connection between the contact of the dummy polysilicon structure and the one of the supply voltage node and the ground node of the integrated circuit, and wherein the electrical connection is formed based on a determination by at least one processor that a spacing between the electrical connection and a nearest electrical path of the integrated circuit exceeds a minimum spacing threshold.

17. The method of claim 15, wherein the first MOSFET device and the second MOSFET device each have a width, a length, and a thickness, and the dummy polysilicon structure extends along the widths of the first MOSFET device and the second MOSFET device and extends substantially perpendicular to the lengths of the first MOSFET device and the second MOSFET device, and wherein the area of the extended active silicon region is calculated by the at least one processor based on a comparison of a difference in the widths of the first MOSFET device and the second MOSFET device with a width difference threshold.

18. The method of claim 17, wherein when the difference in the widths of the first MOSFET device and the second MOSFET device exceeds the width difference threshold, the active silicon region is extended adjacent to the dummy polysilicon structure substantially along the entire width of each of the first MOSFET device and the second MOSFET device.

19. The method of claim 15, wherein the first node and the second node comprise at least two of a supply voltage node coupled to a supply voltage of the integrated circuit, a ground node coupled to a ground of the integrated circuit, and an output node, the output node being configured to have an electric potential different from the supply voltage and the ground.

20. The method of claim 15, wherein the adjacent terminal of the first MOSFET device is a source terminal and the adjacent terminal of the second MOSFET device is a drain terminal.

21. An integrated circuit fabrication system comprising:
at least one processor; and
memory containing executable instructions such that when executed by the at least one processor cause the integrated circuit fabrication system to:
form an electrical connection between a dummy polysilicon structure of an integrated circuit and one of a supply voltage node and a ground node of the integrated circuit based on an electronic search by an integrated circuit design system of a virtual layout of the integrated circuit that locates a plurality of dummy polysilicon structures of the integrated circuit, the electronic search performed by the integrated circuit design system locating the dummy polysilicon structure based on a lack of connection of the dummy polysilicon structure to at least one of a contact layer and a metal layer of the integrated circuit, the dummy polysilicon structure being positioned between an adjacent terminal of a first MOSFET device and an adjacent terminal of a second MOSFET device wherein the adjacent terminal of the first MOSFET device is connected to a first node of the integrated circuit and the adjacent terminal of the second MOSFET device is connected to a second node of the integrated circuit, the first node and the second node being configured to have different electric potentials; and
extend an active silicon region to an area adjacent to the dummy polysilicon structure such that the active silicon region extends from the first MOSFET device to the second MOSFET device and substantially abuts the dummy polysilicon structure.

22. The integrated circuit fabrication system of claim 21, wherein the integrated circuit fabrication system forms the electrical connection by adding a contact to the dummy polysilicon structure and adding a metal connection between the contact of the dummy polysilicon structure and the one of the supply voltage node and the ground node of the integrated circuit, and wherein the electrical connection is formed by the integrated circuit fabrication system based on a determination by one or more processors that a spacing between the electrical connection and a nearest electrical path of the integrated circuit exceeds a minimum spacing threshold.

23. The integrated circuit fabrication system of claim 21, wherein the first MOSFET device and the second MOSFET device each have a width, a length, and a thickness, and the dummy polysilicon structure extends along the widths of the first MOSFET device and the second MOSFET device and extends substantially perpendicular to the lengths of the first MOSFET device and the second MOSFET device, and wherein the area of the extended active silicon region is calculated by one or more processors based on a comparison of a difference in the widths of the first MOSFET device and the second MOSFET device with a width difference threshold.

24. The integrated circuit fabrication system of claim 23, wherein when the difference in the widths of the first MOSFET device and the second MOSFET device exceeds the width difference threshold, the integrated circuit fabrication system extends the active silicon region adjacent to the dummy polysilicon structure substantially along the entire width of each of the first MOSFET device and the second MOSFET device.

25. The integrated circuit fabrication system of claim 21, wherein the first node and the second node comprise at least two of a supply voltage node coupled to a supply voltage of the integrated circuit, a ground node coupled to a ground of the integrated circuit, and an output node, the output node being configured to have an electric potential different from the supply voltage and the ground.

26. The integrated circuit fabrication system of claim 21, wherein the adjacent terminal of the first MOSFET device is a source terminal and the adjacent terminal of the second MOSFET device is a drain terminal.
